(19) United States
(12) Patent Application Publication
(10) Pub. No.: US 2015/0069080 A1
(43) Pub. Date: Mar. 12, 2015

(54) DISPENSING CARTRIDGE INSERT

(71) Applicants: Christopher J. DiMartino, Chesterfield, VA (US); Richard W. Graham, Norwich, CT (US)

(72) Inventors: Christopher J. DiMartino, Chesterfield, VA (US); Richard W. Graham, Norwich, CT (US)

(21) Appl. No.: 14/478,775

(22) Filed: Sep. 5, 2014

Related U.S. Application Data
(60) Provisional application No. 61/874,496, filed on Sep. 6, 2013.

(51) Int. Cl. A61J 7/04; B65D 83/04; A61J 7/00

(52) U.S. Cl. CPC A61J 7/0481; A61J 7/0084; B65D 83/0409
USPC 221/1; 221/121; 221/15

(57) ABSTRACT

A device and a method for dispensing pharmacy/clinic loaded medications are described herein. The device may include multiple chambers, each chamber having stored therein one type of medication. Each chamber may have a cavity located along a rotating drum. Rotation of the drum causes the chamber to dispense the medications according to a defined schedule.

### CROSS-REFERENCE TO PRIOR APPLICATIONS

This application claims priority to and the benefit thereof from U.S. Provisional Patent Application No. 61/874,496, filed Sep. 6, 2013, and titled “DRUG DISPENSING CARTRIDGE INSERT,” the entirety of which is hereby incorporated herein by reference.

### FIELD OF THE DISCLOSURE

The present disclosure relates generally to a method and apparatus for dispensing drugs.

### BACKGROUND OF THE DISCLOSURE

The dispensing and dosing of pharmaceuticals is important for the well-being of patients. There is an unmet need for a device for controlling the type of drug dispensed to a patient and the quantity dispensed.

The disclosure provides a system, a device, and a method that fulfill the aforementioned needs.

### SUMMARY OF THE DISCLOSURE

According to one non-limiting example of the disclosure, a device and a method for storing and dispensing pharmacy/clinic loaded medications is described herein.

A drug dispensing cartridge assembly may comprise a storage reservoir, the storage reservoir comprising one or more chambers for storing one or more drugs to be dispensed and a cavity associated with each of the one or more chambers, each cavity being formed along a rotating drum, wherein the rotating drum is configured to be turned allowing one item of the contents of at least one chamber to fill the associated cavity.

The rotating drum may be configured to receive a first rotation to release an item from at least one chamber and a second rotation to dispense the item.

Each chamber may be specifically sized for the item to be dispensed. According to some aspects, each of the one or more chambers holds a drug of the same type. In other aspects, at least two chambers hold drugs of a different type.

Each cavity may be displaced by an arc length around the circumference of the drum in proportion to the number of chambers.

The rotating drum may be configured to engage with an external turning mechanism. The external turning mechanism may form part of a dispensing machine.

The drug dispensing cartridge assembly may be configured to dispense drugs according to a schedule. The schedule may be configured to cause the contents of each chamber to empty at the same rate.

According to some aspects of the disclosure, a method for dispensing a drug from a drug dispensing cartridge assembly comprises storing a plurality of objects in each of one or more chambers of the drug dispensing cartridge assembly; selecting, based on a rotation of a rotating drum of the drug dispensing cartridge assembly, one of the one or more chambers; and releasing an object from the selected chamber, wherein rotation of the rotating drum causes one object to fill a cavity associated with the selected chamber.

The method may further include dispensing the released object upon a second rotation of the rotating drum.

According to some aspects of the disclosure, each chamber is specifically sized for the item to be dispensed. Each of the one or more chambers holds a drug of the same type, in accordance with some aspects of the disclosure. In other aspects, at least two chambers hold drugs of a different type.

According to some aspects of the disclosure, releasing an object from the chamber is performed based on a schedule.

According to some aspects of the disclosure, the object comprises a pill, a capsule, or a dosage unit.

Additional features, advantages, and embodiments of the disclosure may be set forth or apparent from consideration of the detailed description and drawings. Moreover, it is to be understood that the foregoing summary of the disclosure and the following detailed description and drawings are exemplary and intended to provide further explanation without limiting the scope of the disclosure as claimed.

### BRIEF DESCRIPTION OF THE DRAWINGS

The attached drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a drug dispensing cartridge assembly constructed according to principles of the disclosure; AND

FIG. 2 shows an example of a method for dispensing objects, in accordance with principles of the disclosure.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings and attachment are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

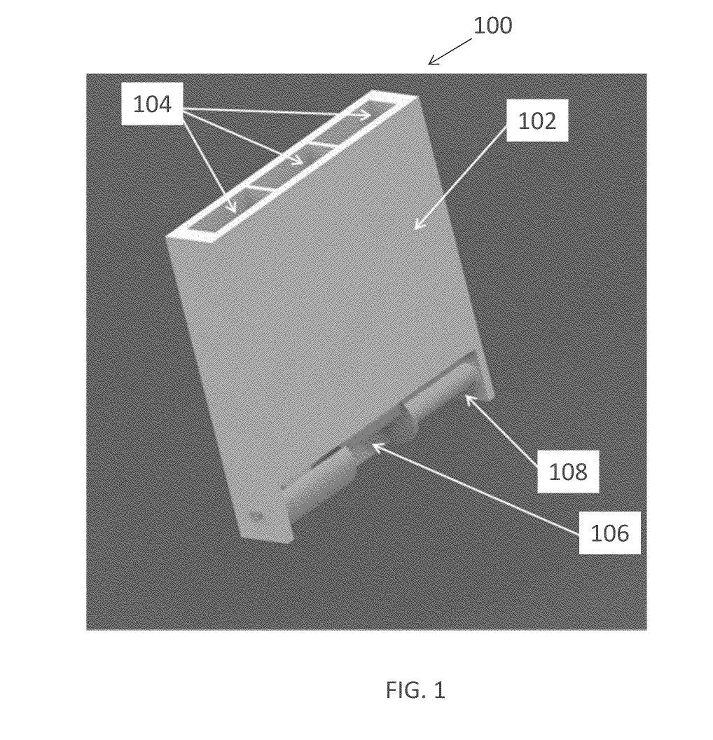

FIG. 1 shows an example of a dispensing cartridge (DC) assembly 100 that is constructed according to the principles of the disclosure. The DC assembly 100 may be configured for use with a drug dispensing machine (not shown), such as the dispensing machine described in U.S. patent application Ser. No. 13/612,568, published as U.S. Patent Application Publication No. US 2013/0088328 on Apr. 11, 2013, which is incorporated herein by reference in its entirety.

The DC assembly 100 may include a storage reservoir 102 having one or more chambers 104 therein for storing drugs to be dispensed. The one or more chambers 104, as well as the reservoir 102, may be sized specifically for the machine (or device) to be dispensed. In some aspects, each chamber may hold the same type of drug. In other aspects, different drug types/strengths may be stored in some or all of the chambers. While three chambers are shown in this example, any number of chambers may be included without departing from the scope of the disclosure.

Each chamber 104 may have aligned therewith a cavity 106. The cavities 106 may be formed along a rotating, dispensing drum 108. Each cavity 106 may be displaced by an arc length around the circumference of the drum 108 in proportion to the number of chambers. Each cavity 106 may be configured to hold one unit of the contents to be dispensed. An external device, such as a motor or manually operated crank, which may be associated with dispensing machine, may cause the drum 108 to turn through an arc sufficient to allow one item of the contents of one of the chambers 104 to fill the appropriate cavity 106 in the rotating drum.

Drum 108 may be configured such that a second rotation through the same arc length dispenses the object that was captured in the original cavity, and exposes the contents of another chamber to its respective cavity in the drum 108. While this example uses a second rotation to dispense the object, in other examples, a single rotation of the drum 108 may cause the object to be captured and released. Dispensing the contents of one chamber does not disturb objects in other, non-selected chambers. The position of the remaining cavities of the drum blocks the contents of the remaining chambers and keeps them from being dispensed until it is their turn in the drum rotation cycle. As described above, the DC assembly 100 may be configured for use with a drug dispensing machine. The drug dispensing machine may cause the drum 108 to rotate and dispense contents of the chamber according to a schedule. The rotation of the drum 108 may be carried out by, e.g., a shaft (not shown) that may be driven by, e.g., a stepping motor, a piezoelectric motor, etc. (not shown). The schedule may cause the contents of the chamber to be dispensed such that each chamber empties at the same rate.

According to an alternative embodiment, drum 108 may include a plurality of drums, each of which may be operated individually and/or separately from the other drums, as will be understood by those skilled in the art. For instance, the plurality of drums may be operated by a plurality of respective shafts (not shown). Each of the plurality of drums may include a single cavity 104.

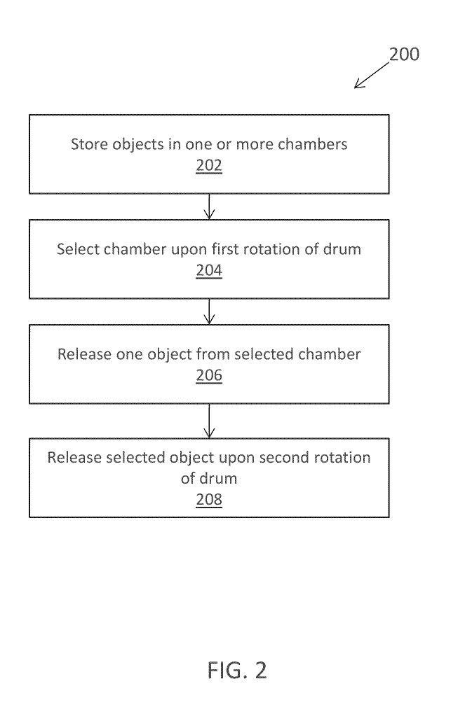

FIG. 2 shows an example of a method 200 for dispensing objects, such as pills, capsules, dosage units, or the like, in accordance with principles of the disclosure. As seen at 202, pills (or dosage units) may be stored in or more chambers 104 of a dispensing cartridge assembly 100. For example, the pills may be loaded into the dispensing cartridge assembly by an authorized provider, such as a pharmacist, pharmacy technician, or any other authorized provider.

As seen at 204, a chamber 104 of the dispensing cartridge assembly 100 may be selected for releasing a pill. For example, upon receipt of a force to turn a drum of the dispenser cartridge, a pill from one chamber may be released. As seen at 206, a cavity 106 associated with chamber 104 releasing the pill may be filled with the released pill. As seen at 208, upon receipt of a second force to further turn the drum, the released pill may be dispensed.

While specific implementations have been described herein of a cartridge used for dispensing drugs/medication, the disclosure is not limited to such implementations. For example, the cartridge described herein may be used to contain and dispense items other than medication such as, for example, packaged food or beverages, canned or otherwise packaged products, and/or any other product that can be dispensed. A cartridge containing such products may be used, for example, in a vending machine or other equipment used to dispense supplies, parts, products, etc. that would fit into a cartridge. Vending machines may be configured to dispense products from the cartridge by electronic or mechanical means. The size and/or shape of the cartridge may vary, depending upon the product to be contained in the cartridge.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A drug dispensing cartridge assembly, comprising:
a storage reservoir, the storage reservoir comprising one or more chambers for storing one or more drugs to be dispensed; and
a cavity associated with each of the one or more chambers, each cavity being formed along a rotating drum,
wherein the rotating drum is configured to be turned allowing one item of the contents of at least one chamber to fill the associated cavity.

2. The drug dispensing cartridge assembly of claim 1, wherein the rotating drum is configured to receive a first rotation to release an item from at least one chamber and a second rotation to dispense the item.

3. The drug dispensing cartridge assembly of claim 1, wherein each chamber is specifically sized for the item to be dispensed.

4. The drug dispensing cartridge assembly of claim 1, wherein each of the one or more chambers holds a drug of the same type.

5. The drug dispensing cartridge assembly of claim 1, wherein at least two chambers hold drugs of a different type.

6. The drug dispensing cartridge assembly of claim 1, wherein each cavity is displaced by an arc length around the circumference of the drum in proportion to the number of chambers.

7. The drug dispensing cartridge assembly of claim 1, wherein the rotating drum is configured to engage with an external turning mechanism.

8. The drug dispensing cartridge assembly of claim 7, wherein the external turning mechanism forms part of a dispensing machine.

9. The drug dispensing cartridge assembly of claim 1, wherein the drug dispensing cartridge assembly is configured to dispense drugs according to a schedule.

10. The drug dispensing cartridge assembly of claim 9, wherein the schedule is configured to cause the contents of each chamber to empty at the same rate.

11. The drug dispensing cartridge assembly of claim 1, wherein the one or more drugs comprises one or more of pills, capsules, or dosage units.

12. A method for dispensing a drug from a drug dispensing cartridge assembly, comprising:
storing a plurality of objects in each of one or more chambers of the drug dispensing cartridge assembly;
selecting, based on a rotation of a rotating drum of the drug dispensing cartridge assembly, one of the one or more chambers; and
releasing an object from the selected chamber,
wherein rotation of the rotating drum causes one object to fill a cavity associated with the selected chamber.

13. The method of claim 1, further comprising:
dispensing the released object upon a second rotation of the rotating drum.

14. The method of claim 1, wherein each chamber is specifically sized for the item to be dispensed.

15. The method of claim 1, wherein each of the one or more chambers holds a drug of the same type.

16. The method of claim 1, wherein at least two chambers hold drugs of a different type.

17. The method of claim 1, wherein releasing an object from the chamber is performed based on a schedule.

18. The method of claim 1, wherein object comprises a pill, a capsule, or a dosage unit.
